(19) United States
(12) Patent Application Publication
(10) Pub. No.: US 2017/0171274 A1
(43) Pub. Date: Jun. 15, 2017

(54) METHOD AND ELECTRONIC DEVICE FOR SYNCHRONOUSLY PLAYING MULTIPLE-CAMERAS VIDEO

(71) Applicants: LE HOLDINGS (BEIJING) CO., LTD., Beijing (CN); LE SHI INTERNET INFORMATION & TECHNOLOGY CORP., BEIJING, Beijing (CN)

(72) Inventor: Jiong WANG, Beijing (CN)

(21) Appl. No.: 15/239,791

(22) Filed: Aug. 17, 2016

Related U.S. Application Data
(63) Continuation of application No. PCT/CN2016/088667, filed on Jul. 5, 2016.

(30) Foreign Application Priority Data
Dec. 11, 2015 (CN) 201510920806.7

(51) Int. Cl. H04L 29/06; H04L 29/08

(52) U.S. Cl. CPC H04L 65/601; H04L 67/02

(57) ABSTRACT

The present disclosure discloses a method and an electronic device for synchronously playing multiple-cameras video, the method includes: obtaining, by a terminal, multiple-cameras video data source information of a video program from a network server; determining, by the terminal, a selected camera site after the terminal obtaining multiple click operations of a user on a camera site information list, and transmitting a data request to the network server; and sequentially playing, by the terminal, the video content of the selected camera site in a main play window and a subordinate play window after the terminal receives the data. The present disclosure also discloses an apparatus for synchronously playing multiple-cameras video, wherein the terminal includes an information obtaining module, a request transmitting module, and a video playing module; and the network server includes an information transmitting module and a request executing module.

### CROSS-REFERENCE TO RELATED APPLICATIONS

The present disclosure is a continuation of International Application No. PCT/CN2016/088667, with an international filing date of Jul. 5, 2016, which claims priority to Chinese Patent Application No. 201510920806.7, titled as “METHOD AND APPARATUS FOR SYNCHRONOUSLY PLAYING MULTIPLE-CAMERAS VIDEO”, filed with State Intellectual Property Office on Dec. 11, 2015, which is incorporated herein by reference in its entirety.

### TECHNICAL FIELD

The present disclosure relates to the field of Webcast, and in particular to a method and an electronic device for synchronously playing multiple-cameras video.

### BACKGROUND

Webcast can be substantially divided into two types, one is providing TV signals, such as live broadcast of various sports games and cultural activities, for viewing through the Internet, and the principle of this type of live broadcast is that the TV signals are collected and then converted into digital signals to be input to computers, and then uploaded in real time to websites for viewing by people; when a user is watching this type of live programs, he/she just passively receives the contents of the programs following the broadcast progress. The viewing angle of the user is switched in a passive way, i.e. determined by TV station. The user may wait for replay or watch post editing if he/she wants to view wonderful scenes.

The other type is putting an independent signal input device on the site to guide the signals into the instructor terminals, and then signals are uploaded to servers through a network and posted to websites, such that users can selectively view the contents on clients according to their demands; for this type of live broadcast, users can select different viewing angles according to their viewing demands. However, if a user wants to watch the content in other viewing angles while watching it in a specific viewing angle, for example, during a live broadcast of a match in football world cup, the user selects panoramic camera video to view the panorama while intending to view close-up shots of his/her favorite football star, at this time, the user may repeatedly switch between the panoramic camera video and close-up camera video, without fulfilling the demands of the user to watch both videos at the same time.

### SUMMARY

According to a first aspect of the present disclosure, the method for synchronously playing multiple-cameras video provided by the embodiment of the present disclosure based on the above described purpose is applied to a terminal, and the method includes:

Obtaining multiple-cameras video data source information of a video program from a network server, and generating and displaying a camera site information list;

Setting up a main play window and at least one subordinate play window;

Determining a camera site selected by a user after obtaining a first click operation of the user on the camera site information list, and transmitting a request for obtaining the first selected camera video data to the network server;

Playing video content of the first selected camera site on the main play window after the first selected camera video data is received;

Determining a camera site selected by the user after obtaining a second click operation of the user on the camera site information list, and transmitting a request for obtaining the second selected camera video data to the network server;

Playing video content of the second selected camera site on the at least one subordinate play window after the second selected camera video data is received.

According to a second aspect of the embodiment of the present disclosure, further provides a non-volatile computer-readable storage medium storing computer-executable instructions configured to execute any one of the above methods for synchronously playing multiple-cameras video.

According to a third aspect of the embodiment of the present disclosure, further provides an electronic device including: one or more processors; and a memory communicably connected with the at least one processor, the memory is stored with instructions executable by the one or more processors, and the instructions configured to execute any one of the above methods for synchronously playing multiple-cameras video.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flowchart schematically illustrating embodiment 1 in which the method for synchronously playing multiple-cameras video is applied to a terminal, provided by the disclosure.

FIG. 2 is a flowchart schematically illustrating embodiment 2 in which the method for synchronously playing multiple-cameras video is applied to a terminal, provided by the disclosure.

FIG. 3 is a schematic drawing illustrating an embodiment of horizontal screen displaying effect of the synchronous playing of multiple-cameras video, provided by the disclosure.

FIG. 4 is a schematic drawing illustrating an embodiment of vertical screen displaying effect of the synchronous playing of multiple-cameras, provided by the disclosure.

FIG. 5 is a flowchart schematically illustrating embodiment 1 in which the method for synchronously playing multiple-cameras video is applied to a network server, provided by the disclosure.

FIG. 6 is a flowchart schematically illustrating embodiment 2 in which the method for synchronously playing multiple-cameras video is applied to a network server, provided by the disclosure.

FIG. 7 is a flowchart schematically illustrating embodiment 3 in which the method for synchronously playing multiple-cameras video is applied to a network server, provided by the disclosure.

FIG. 8 is a schematic drawing illustrating an embodiment of the apparatus for synchronously playing multiple-cameras video, provided by the disclosure.

FIG. 9 is a block diagram of the embodiment 1 of the electronic device for synchronously playing multiple cameras video, provided by the disclosure.

FIG. 10 is a block diagram of the embodiment 2 of the electronic device for synchronously playing multiple cameras video, provided by the disclosure.

### DETAILED DESCRIPTION

In order to make the objects, technical solutions and advantages of the present disclosure more apparent, the disclosure is further described in details in conjunction with specific embodiments and with reference to the accompanying drawings.

It should be noted that all the expressions of “first” and “second” used in the embodiments of the disclosure are used for distinguishing two different entities or different parameters with the same name, it can be seen that “first” and “second” are only used to facilitate the expressions, and should not be deemed as limiting the embodiments of the disclosure, and the subsequent embodiments will not explain them in details.

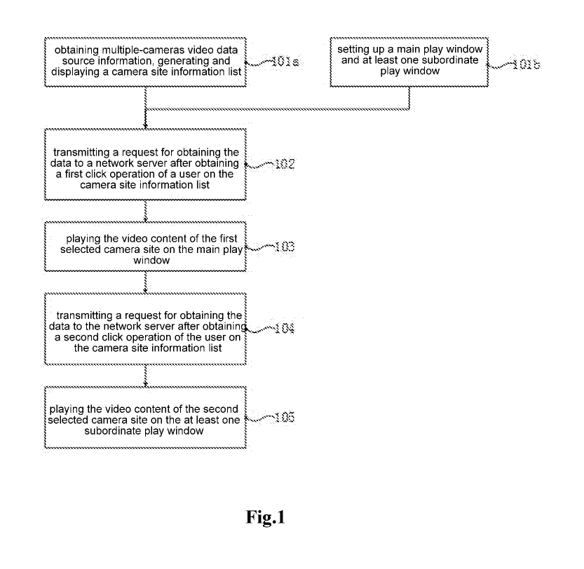

FIG. 1 shows an embodiment in which the method for synchronously playing multiple-cameras video, provided by the disclosure, is applied to a terminal.

The method for synchronously playing multiple-cameras video is applied to a terminal, and the method includes the following steps:

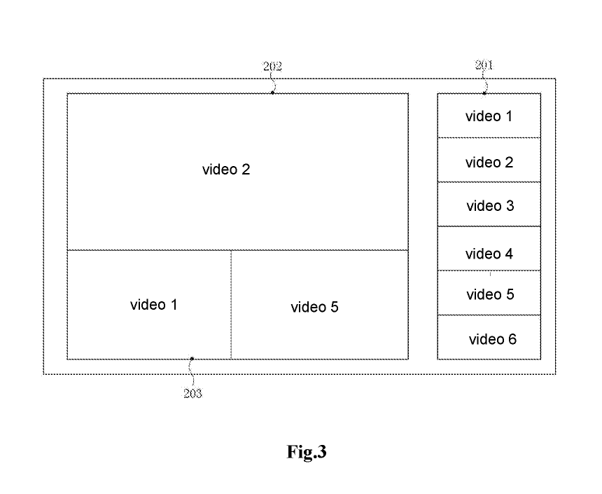

In step 101a, multiple-cameras video data source information of a video program from a network server is obtained, and a camera site information list 201 (as shown in FIG. 3) is generated and played;

In step 101b, both a main play window and at least one subordinate play window are set up;

In step 102, a camera site selected by a user is determined after a first click operation of the user on the camera site information list 201 is obtained, and a request for obtaining the first selected camera video data is transmitted to the network server;

In step 103, video content of the first selected camera site is played on the main play window 202 after the first selected camera video data is received;

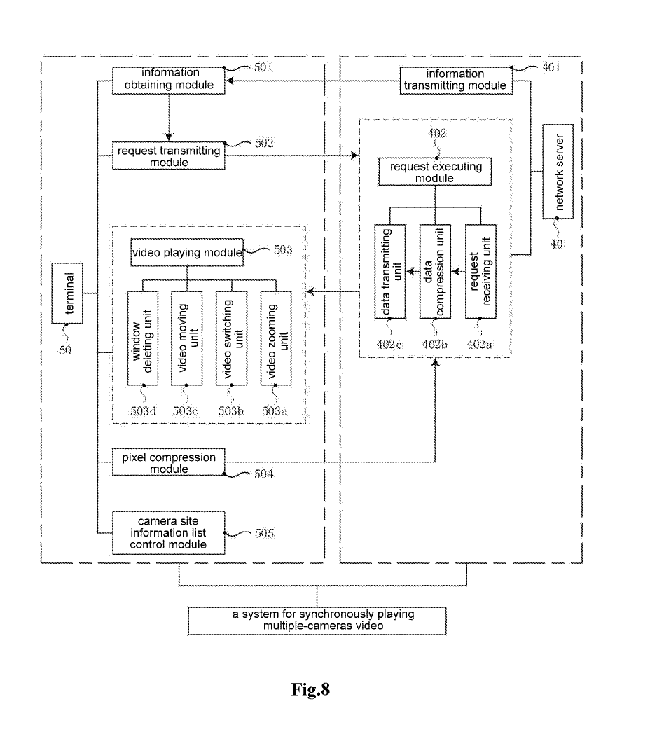

In step 104, a camera site selected by the user is determined after a second click operation of the user on the camera site information list is obtained, and a request for obtaining the second selected camera video data is transmitted to the network server 40 (as shown in FIG. 8);

In step 105, video content of the second selected camera site is played on at least one subordinate play window 203 after the second selected camera video data is received.

When two subordinate play windows are set, the method can further includes the following steps: a camera site selected by the user is determined after a third click operation of the user on the camera site information list is obtained, and a request for obtaining the third selected camera video data is transmitted to the network server 40 (as shown in FIG. 8); and the video content of the third selected camera site is played on the playing window 203 after the third selected camera video data is received.

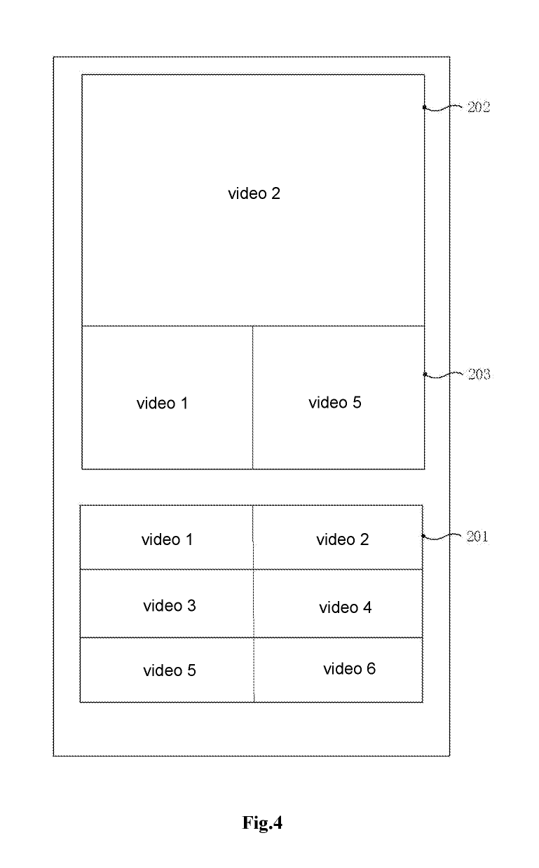

For example, as shown in FIG. 3 and FIG. 4, one live program includes multiple cameras corresponding to videos 1, 2, 3, 4, 5 and 6, and the terminal is provided with one main play window 202 and two subordinate play windows 203. The user first clicks the video 2 on the camera site information list 201, and the video 2 is played on the main play window 202; the user then clicks the video 1, and the video 1 is played on the first subordinate play window; the user later clicks the video 5, and the video 5 is played on the second subordinate play window; if the user continues to click the camera site information list 201, for example clicks the video 4, then the video 5 is played on the first subordinate play window, and the video 4 is played on the second subordinate play window.

After the user opens a live client, he/she can select several live camera videos to be played in order, such that the most favorable camera video of the user is disposed on the main play window 202, with the program being played synchronously on the main play window and the subordinate play windows, thereby the user's demands for synchronously watching live programs in multiple viewing-angles are satisfied. The arrangement of two subordinate play windows can meet user's requirements for multiple-window viewing while preventing visual confusion caused by excessive windows.

When the terminal is in a vertical screen display mode, as shown in FIG. 3, the camera site information list 201 can be displayed at the lower part of the subordinate play window 203.

Furthermore, the source information of the multiple-cameras video data includes download address of each camera video data and camera identity information of a video program, wherein the camera identity information is contained in the camera site information list 201.

The step of transmitting the request for obtaining the selected camera video data to the network server includes: transmitting the request for obtaining the selected camera video data according to the camera video data download address of the selected camera video data.

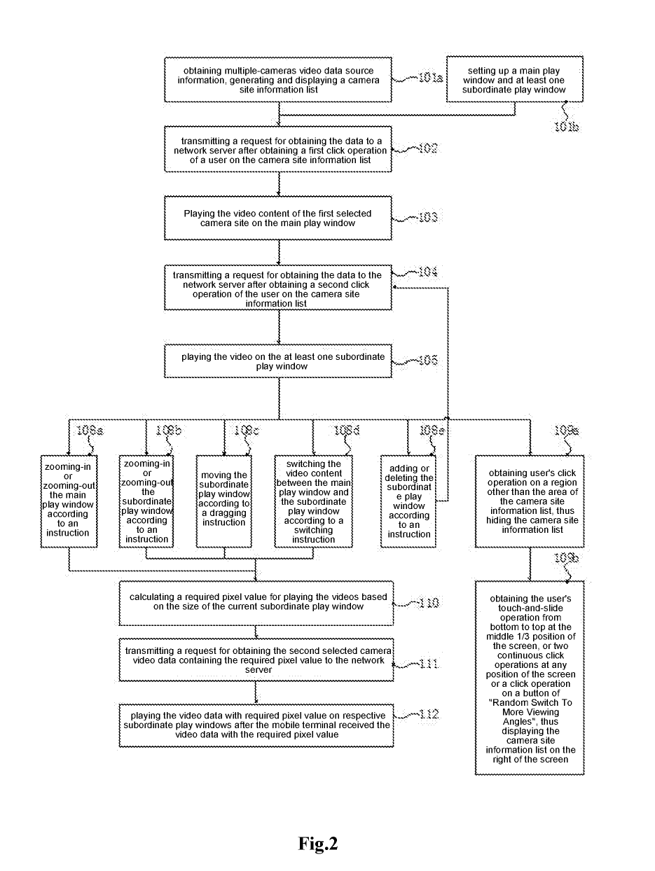

As shown in FIG. 2, in another embodiment provided by the disclosure, the transmitting of the request for obtaining the second selected camera video data to the network server in step 104 includes: requesting the second selected camera video data to be compressed and obtaining the compressed second selected camera video data, and electively, the second selected camera video data is compressed to 60% of the original data.

The receiving the second selected camera video data includes: receiving the compressed second selected camera video data, and displaying it on at least one subordinate play window 203 with the compressed pixel value.

The videos are watched on the terminal by accessing wireless network or using data traffic, and network data quantity should be reduced as far as possible in playing the videos so as to avoid a waste of traffic. Since the second selected camera video is the video to be played on the subordinate play window and the subordinate play window is smaller than the main play window, playing the videos on the subordinate play window with the compressed low pixel value can not only meet the viewing demands but also reduce the quantity of network data.

Furthermore, the method for synchronously playing multiple-cameras video provided by the disclosure further includes:

In step 108a, an instruction for zooming-in or zooming-out the main play window 202 is received, and the main play window 202 is zoomed-in or zoomed-out according to the instruction;

In step 108b, an instruction for zooming-in or zooming-out the subordinate play window 203 is received, and zooming-in or zooming-out the subordinate play window 203 is zoomed-in or zoomed-out according to the instruction;

Electively, the zooming-in instruction includes: sliding the thumb and index finger outwards synchronously on a window to be zoomed, and the zooming-out instruction includes: sliding the thumb and index finger inwards synchronously on a window to be zoomed;

In step 108c, an instruction for dragging the subordinate play window 203 is received, and the subordinate play window 203 is moved according to the dragging instruction;

In step 108d, an instruction for switching between the main play window 202 and the subordinate play window 203 is received, and according to the switching instruction, the corresponding video content of the subordinate play window 203 is loaded to the main play window 202 for playing, and the video content of the main play window is loaded to the subordinate play window for playing;

Electively, the switching instruction includes: dragging the subordinate play window 203 to move towards the screen top, and stopping dragging the subordinate play window 203 until less than ⅔ of the subordinate play window is displayed within the screen.

Furthermore, the method for synchronously playing multiple-cameras video provided by the disclosure further includes:

In step 108e, an instruction for adding or deleting the subordinate play window 203 is received, and the subordinate play window 203 is added or deleted according to the instruction; electively, the adding or deleting instruction includes: long pressing any one of the subordinate play windows to display a clickable button for adding or deleting a window at the upper part of the subordinate play window;

After executing the instruction for adding the subordinate play window, it returns to execute step 104.

According to his/her own viewing demands, the user can adjust the sizes and positions of the main play window 202 and the subordinate play window 203, for example, the user can drag and drop the subordinate play window into the playing picture of the main play window for playing, and adjust the position and size of the subordinate play window according to the playing picture of the main play window so as to prevent the major picture from being shadowed. As a result, the main play window can be viewed more clearly and the video on the subordinate play window can be viewed at the same time; meanwhile, the user can switch the video between the main play window and the subordinate play window according to his/her own needs, or select the number of the subordinate play window 203.

The method further includes:

In step 109a, a click operation of the user on a region other than the area of the camera site information list 201 is obtained, thus the camera site information list 201 is hided;

In step 109b, the user's slide operation from bottom to top at the middle ⅓ position of the screen, or two continuous click operations at any position of the screen or a click operation on a button of “Random Switch to More Viewing Angles” are obtained, thus the camera site information list 201 is displayed on the right of the screen.

By hiding the camera site information list 201, the playing interface will be more concise, the interference to the video picture by other pictures will be reduced, and the region for playing videos will be increased; when the video switching is needed, the camera site information list 201 is called out through an operational instruction, wherein the way of calling out the camera site information list 201 includes: the slide operation from bottom to top at the middle ⅓ position of the screen, or continuous two click operations at any position of the screen, or the click operation on the button “Random Switch to More Viewing Angles”, may be set according to the use habit of the user. Alternatively, other instructions may also be set according to requirements to call out the camera site information list 201.

After the camera site information list 201 is hidden, the main play window 202 and the subordinate play window 203 can be changed to full screen playing mode automatically, for example, the main play window 202 and the subordinate play window 203 can fill the whole screen; when the camera site information list 201 is called out, the size of the main play window 202 and the subordinate play window 203 can be adjusted automatically to reserve place for the camera site information list 201, or the camera site information list 201 can be overlapped in the playing window for displaying.

The method furthermore includes: step 110, a required pixel value for playing the videos is calculated based on the size of the current subordinate play window 203;

In step 111, a request for obtaining the second selected camera video data containing the required pixel value is transmitted to the network server 40 (as shown in FIG. 8);

In step 112, the video data with required pixel value compressed from the second selected camera video data by the network server 40 (as shown in FIG. 8) is received, and then it is played on the corresponding subordinate play window 203.

When there are multiple subordinate play windows, steps 110, 111, and 112 are executed repeatedly.

When the window size changes, the original video pixel no longer fits the current window size or the pixel value is so small that causes deterioration in the picture quality, or the pixel value is so high that causes unnecessary resource consumption that causes lagging of the Webcast, hence the pixel value for video playing can be adjusted along with the size of the window, such that the viewing demands can be meet while avoiding a waste of network resources.

As can be seen from the above-described embodiments, the method for synchronously playing multiple-cameras video, provided by the disclosure, generates and displays the camera site information list 201 by obtaining the multiple-cameras video data source information of a video program, obtains the user's click operation on the camera site information list 201, determines the camera site selected by the user, transmits a request for obtaining the selected camera video data to the network server, and sequentially plays the video content of the selected camera site on the main play window 202 and at least one subordinate play window 203, so that the purpose of synchronously playing multiple live videos is achieved, and the user experience is enriched; the playing interface of the terminal is simplified by hiding or calling out the camera site information list 201, and different viewing demands of the user can be met, and more user-oriented operation experience is provided to the user by switching between the main play window and the subordinate play window and setting the sizes and positions of the windows.

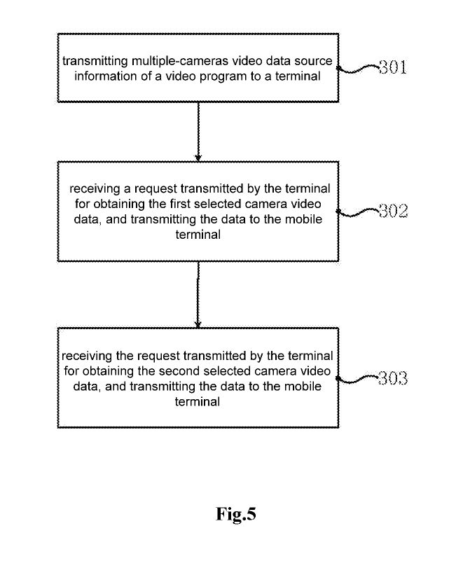

The disclosure also provides a method for synchronously playing multiple-cameras video, as shown in FIG. 5, applied to a network server, and the method includes:

In step 301, multiple-cameras video data source information of a video program is transmitted to a terminal, and a camera site information list is generated at the terminal;

In step 302, a request transmitted by the terminal for obtaining the first selected camera video data is received, and the first selected camera video data is transmitted to the terminal, and the corresponding video is played on the main play window 202 of the terminal;

In step 303, a request transmitted by the terminal for obtaining the second selected camera video data is received, and the second selected camera video data is transmitted to the terminal, and the corresponding video is played on the subordinate play window 203 of the terminal 50 (as shown in FIG. 8);

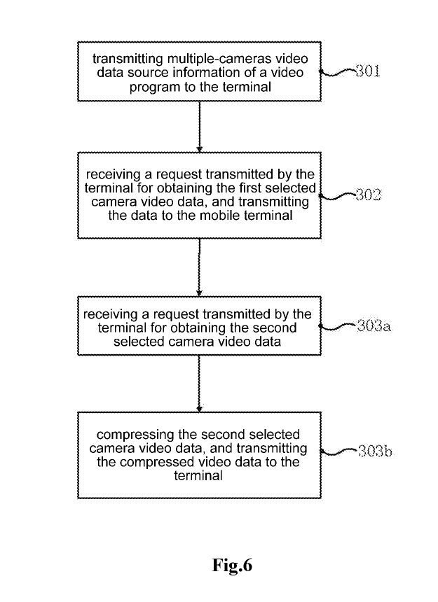

Furthermore, as shown in FIG. 6, step 303 specifically includes: In step 303a, a request transmitted by the terminal 50 (as shown in FIG. 8) for obtaining the second selected camera video data is received,

In step 303b, the second selected camera video data is compressed and then the compressed video data is transmitted to the terminal.

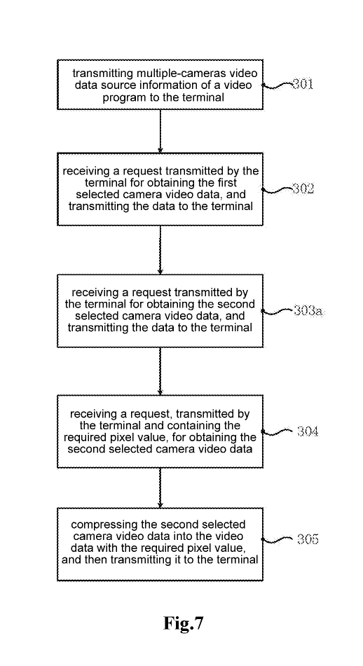

The method further includes: as shown in FIG. 7, in step 304, a request is received, which is transmitted by the terminal 50 (as shown in FIG. 8) and containing the required pixel value, for obtaining the second selected camera video data,

In step 305, the second selected camera video data is compressed to video data with required pixel value and then it is transmitted to the terminal.

Since the second selected camera video is the video to be played on the subordinate play window and the subordinate play window is smaller than the main play window, playing the video with the compressed low pixel value on the subordinate play window can not only meet the viewing demands but also reduce the quantity of network data. It should be particularly noted that individual steps in the embodiments of the method above-mentioned can be properly interchanged, replaced, added or deleted, therefore, these rational arrangement, combination and alternation fall into the scope of the present disclosure, and the embodiments do not represent limitations to the scope of the present disclosure.

In another aspect, the present disclosure provides an apparatus for synchronously playing multiple-cameras video, referring to FIG. 8, includes:

An information obtaining module 501 obtains multiple-cameras video data source information of a video program from a network server, and generates and displays a video information list;

A request transmitting module 502 determines a camera site selected by a user after obtaining a first click operation of the user on the camera site information list 201, and transmits a request for obtaining first selected camera video data to the network server 40, and determines a camera site selected by the user after obtaining a second click operation of the user on the camera site information list 201, and transmits a request for obtaining second selected camera video data to the network server 40;

A video playing module 503 includes a main play window and at least one subordinate play window, after the first selected camera video data is received, video content of the first selected camera site is played on the main play window 202 and after the second selected camera video data is received, video content of the second selected camera site is played on the at least one subordinate play window 203.

The display mode of the video playing module is generally horizontal screen display, as shown in FIG. 3, the camera site information list 201 contains videos 1, 2, 3, 4, 5, and 6, and the terminal is provided with one main play window 202 and two subordinate play windows 203. The user first clicks the video 2 in the camera site information list 201, and the video 2 is displayed on the main play window 202, the user then clicks the video 1, and the video 1 is displayed on the first subordinate play window, the user later clicks the video 5, and the video 5 is displayed on the second subordinate play window. When the user continues to click the camera site information list 201, for example, click the video 4, the video 5 is played on the first subordinate play window, and the video 4 is played on the second subordinate play window; when the user needs vertical-screen display of the video to be played, as shown in FIG. 4, the camera site information list 201 can be displayed at the lower part of the subordinate play window 203.

The videos can be played in the main and subordinate play windows at the same time via the video playing module 503, thus user's demands for viewing live programs in multiple viewing angles are satisfied. The arrangement of two subordinate play windows can meet user's needs of multi-window viewing while preventing visual confusion caused by excessive windows.

Furthermore, the request transmitting module 502 makes a request for compressing the second selected camera video data to the network server 40 and obtains the compressed second selected camera video data;

The video playing module 503 plays the video content of the second selected camera site on the at least one subordinate play window after the compressed second selected camera video data is received. Furthermore, the apparatus also includes a pixel compression module 504 that enables the network server to compress the second selected camera video data and then transmits it to the terminal after a request for obtaining the second selected camera video data is transmitted to the network server;

The video playing module 503 plays the compressed second selected camera video data with compressed pixel value after the compressed second selected camera video data is received.

Since the second selected camera video is the video to be played on the subordinate play window and the subordinate play window is smaller than the main play window, playing the videos with compressed low pixel value on the subordinate play window can not only meet the viewing demands but also reduce the quantity of network data.

Furthermore, the video playing module 503 includes:

A video zooming unit 503a receives an instruction for zooming-in or zooming-out the main play window, and zooms in or zooms out the main play window according to the instruction, and receives an instruction for zooming-in or zooming-out the subordinate play window, and zooms in or zooms out the subordinate play window according to the instruction; electively, the zooming-in instruction includes: sliding the thumb and index finger outwards synchronously on a window to be zoomed, and the zooming-out instruction includes: sliding the thumb and index finger inwards synchronously on a window to be zoomed;

A video switching unit 503b receives an instruction for switching the main and subordinate play windows, and according to the switching instruction, loads the corresponding video content on the subordinate play window to the main play window for playing, and loads the video content on the main play window to the subordinate play window for playing; electively, the switching instruction includes: dragging the subordinate play window to move towards the screen top, and stopping dragging the subordinate play window until less than ⅔ of the subordinate play window is displayed within the screen;

A video moving unit 503c receives an instruction for dragging the subordinate play window, and moves the subordinate play window according to the dragging instruction.

The video playing module 503 further includes: a window deleting unit 503d, by which an instruction for adding or deleting the subordinate play window is received, and the subordinate play window is added and deleted according to the instruction; electively, the adding or deleting instruction includes: long pressing any one of the subordinate play windows to display a clickable button for adding or deleting a window at the upper part of the subordinate play window.

According to his/her own viewing needs, the user can switch between the main play window 202 and the subordinate play window 203 or adjust the sizes or positions thereof, for example, the user can drag and drop the subordinate play window into the playing picture of the main play window for playing, and can adjust the position and size of the subordinate play window according to the playing picture on the main play window so as to prevent the major picture from being shadowed, as a result, the main play window can be viewed more clearly and the video on the subordinate play window can be viewed at the same time; meanwhile, the user can delete or add the subordinate play window if necessary.

Furthermore, it also includes a pixel compression request module 504 that calculates a required pixel value for playing the video according to the size of the current subordinate play window, and transmits a request for obtaining the second selected camera video data containing the required pixel value to the network server 40;

The video playing module 503 performs playing on the corresponding subordinate play window 203 after the video data with required pixel value compressed is received from the second selected camera video data by the network server 40.

The pixel value of the playing video is adjusted along with the size of the playing window, such that the viewing demands can be meet while avoiding a waste of network resources.

Furthermore, the apparatus for synchronously playing multiple-cameras video provided by the disclosure also includes: a camera site information list control module 505, a click operation of a user on a region other than the area of the camera site information list 201 is obtained, thereby hiding the camera site information list;

And the apparatus obtain a user's touch-and-slide operation from bottom to top at the middle ⅓ position of the screen, or continuous two click operations of the user at any position of the screen, or a click operation of the user on a button “Random Switch to More Viewing Angles”, thus display the camera site information list on the right of the screen.

The camera site information list control module 505 makes the playing interface of the camera site information list simpler by hiding, such that interference of other pictures to video pictures is reduced, meanwhile, the area for playing video is increased. When video switching is required, the camera site information list 201 may be called out through an operational instruction, wherein the way of calling out the camera site information list 201 includes: a slide operation from bottom to top at the middle ⅓ position of the screen, or continuous two click operations at any position of the screen, or a click operation on the button “Random Switch to More Viewing Angles”, which may be set according to the use habit of a mobile user. Alternatively, other instructions may also be set according to requirements to call out the camera site information list 201.

More broadly, all instructions that can be obtained by means of user's operation gestures, such as the switching instruction, the zooming instruction, the instruction for hiding or calling out the camera list, and the like, can be set to user-defined modes. That is, a user can click the set button on a terminal to define the gesture of each operation step according to his/her own use habits and interested points.

The disclosure also provides an apparatus for synchronously playing multiple-cameras video. The apparatus is applied to a network server, and includes:

An information transmitting module 401 transmits multiple-cameras video data source information of a video program to a terminal;

A request executing module 402 receives a request transmitted by the terminal 50 (as shown in FIG. 8) for obtaining first selected camera video data, and transmits the first selected camera video data to the terminal 50, and receives a request transmitted by the terminal 50 for obtaining second selected camera video data, and transmits the second selected camera video data to the terminal 50.

Furthermore, the request executing module 402 includes: a request receiving unit 402a, the request transmitted by the terminal 50 for obtaining the first selected camera video data is received, and the request transmitted by the terminal 50 for obtaining the second selected camera video data is received;

A data compression unit 402b compresses the second selected camera video data after the request receiving unit received the request transmitted by the terminal 50 for obtaining the second selected camera video data;

And a data transmitting unit 402c transmits the first selected camera video data to the terminal 50, and transmits the compressed second selected camera video data to the terminal 50.

Furthermore, the request receiving unit 402a receives a request, transmitted by the terminal 50 and including a desired pixel value, for obtaining the second selected camera video data.

The data compression unit 402b compresses the second selected camera video data into video data with the desired pixel value after the request receiving unit receives the request, transmitted by the terminal 50 and containing the desired pixel value, for obtaining the second selected camera video data.

The data transmitting unit 402c transmits the video data with the desired pixel value compressed from the second selected camera video data to the terminal.

The disclosure also provides a terminal that includes part of or all units of the apparatus for synchronously playing multiple-cameras video provided by the embodiments as shown in FIG. 1 to FIG. 4. The terminal may include a processor and a memory. The memory is used for storing instructions, while the processor is used for executing the instructions stored in the memory to implement part of or all steps in various implementations of a method for synchronously playing multiple-cameras video provided by the embodiments as shown in FIG. 1 to FIG. 4.

The present disclosure also provides a network server that includes part of or all units of an apparatus for synchronously playing multiple-cameras video provided by the embodiments as shown in FIG. 5 to FIG. 7. The network server may include a processor and a memory. The memory is used for storing instructions, while the processor is used for executing the instructions stored in the memory to implement part of or all steps in various implementations of a method for synchronously playing multiple-cameras video provided by the embodiments as shown in FIG. 5 to FIG. 7.

In another aspect, the present disclosure also provides a system for synchronously playing multiple-cameras video. The system includes a terminal 50 and a network server 40.

The terminal 50 includes an information obtaining module 501, a request transmitting module 502, and a video playing module 503, while the network server 40 includes an information transmitting module 401 and a request executing module 402.

The information obtaining module 501 generates and displays a camera site information list upon receiving multiple-cameras video data source information of a video program transmitted by the information transmitting module 401.

After obtaining a first click operation of a user on the camera site information list 201, the request transmitting module 502 determines a camera site selected by the user, and transmits a request for obtaining the first selected camera video data to the request executing module 402 of the network server 40. The request executing module 402 receives the request transmitted by the terminal 50 for obtaining the first selected camera video data, and transmits the first selected camera video data to the terminal 50. The video playing module 503 includes a main play window and at least one subordinate play window, wherein the video content of the first selected camera site is played on the main play window 202 after the first selected camera video data is received.

After obtaining a second click operation of the user on the camera site information list 201, the request transmitting module 502 determines a camera site selected by the user, and transmits a request for obtaining second selected camera video data to the request executing module 402 of the network server 40. The request executing module 402 receives the request transmitted by the terminal 50 for obtaining the second selected camera video data, and transmits the second selected camera video data to the terminal 50. The video playing module 503 plays the video content of the second selected camera site on the at least one subordinate play window 203 after the second selected camera video data is received.

Furthermore, the request executing module 402 includes a request receiving unit 402a, a data compression unit 402b, and a data transmitting unit 402c.

The request transmitting module 502 may transmit a request for compressing the second selected camera video data and obtaining the compressed second selected camera video data to the request receiving unit 402a of the network server 40. After the request receiving unit 402a receives the request, the data compression unit 402b compresses the second selected camera video data, and the data transmitting unit 402c transmits the compressed second selected camera video data to the terminal 50.

The request receiving unit 402a may also receive the request transmitted by the terminal 50 for obtaining the first selected camera video data, and then the data transmitting unit 402 may transmit the first selected camera video data to the terminal 50.

Furthermore, the terminal 50 also includes a pixel compression request module 504 that calculates a required pixel value for playing the video according to the size of the current subordinate play window, transmits a request for obtaining the second selected camera video data containing the required pixel value to a request receiving unit 402a of a network server. After the request receiving unit 402a receives the request, the data compression unit 402b compresses the second selected camera video data into video data with the required pixel value, and the data transmitting unit 402c transmits the video data with required pixel value compressed from the second selected camera video data to the terminal 50;

The video playing module 503 of the terminal 50 receives the second selected camera video data compressed according to the required pixel value and then plays it on the corresponding subordinate play window 203.

Furthermore, the video playing module 503 also includes a video zooming unit 503a, an instruction for zooming-in or zooming-out a main play window is received, and the main play window is zoomed-in or zoomed-out according to the instruction, and an instruction for zooming-in or zooming-out an subordinate play window is received, and the subordinate play window is zoomed-in or zoomed-out according to the instruction; electively, the zooming-in instruction includes: sliding the thumb and index finger outwards synchronously on a window to be zoomed, and the zooming-out instruction includes: sliding the thumb and index finger inwards synchronously on a window to be zoomed;

A video switching unit 503b receives an instruction for switching the main and subordinate play windows, and according to the switching instruction, loads the corresponding video content on the subordinate play window to the main play window for playing, and loads the video content of the main play window to the subordinate play window for playing; electively, the zooming-in instruction includes: dragging the subordinate play window to move towards the screen top, and stopping dragging the subordinate play window until less than ⅔ of the subordinate play window is displayed within the screen;

A video moving unit 503c receives an instruction for dragging the subordinate play window, and moves the subordinate play window according to the dragging instruction.

The video playing module 503 also includes a window deleting unit 503d, an instruction for adding or deleting the subordinate play window is received, and the subordinate play window is added or deleted according to the instruction; electively, the adding or deleting instruction includes: long pressing any one of the subordinate play windows to display a clickable button for adding or deleting a window at the upper part of the subordinate play window. The method and apparatus for synchronously playing multiple-cameras video provided by the present disclosure, generate and display a camera site information list by obtaining multiple-cameras video data source information of a video program, obtain a click operation of a user on the camera site information list, transmit a request for obtaining the selected camera video data to the network server according to the determination of the camera site selected by the user, and play the video content of the selected camera site on the main play window and at least one subordinate play window in sequence, such that the purpose of playing multiple live videos synchronously is achieved, while the user can select his or her favorable viewing angle according to his/her demands, and user experience is enriched, and by switching between the main and subordinate play windows and setting the sizes and positions of the windows or deleting, or adding the subordinate play window, different viewing needs can be met, thereby providing more user-oriented operation experience to the user.

The embodiments of the disclosure also provides a non-volatile computer storage medium storing computer-executable instructions configured to execute the method for synchronously playing multiple-cameras video provided in any method embodiments as shown in FIG. 1 to FIG. 4.

The embodiments of the present disclosure also provides another non-volatile computer storage medium storing computer-executable instructions configured to execute the method for synchronously playing multiple-cameras video provided in any method embodiments as shown in FIG. 5 to FIG. 7.

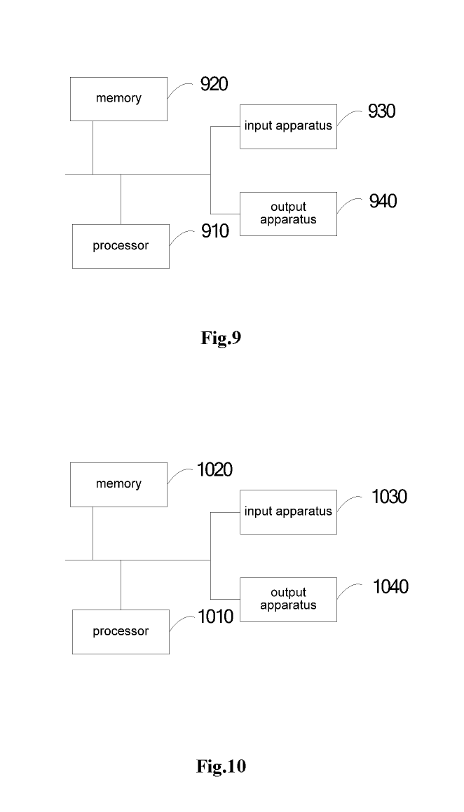

FIG. 9 is a block diagram of the embodiment 1 of the electronic device for synchronously playing multiple cameras video, provided by the present disclosure. As shown in FIG. 9, the device includes:

One or more processors 910 and memory 920. In FIG. 9, take one processor 910 as the example.

The device for executing the method for synchronously playing multiple-cameras video may further include: input device 930 and output device 940.

The processor 910, memory 920, input device 930 and output device 940 can be connected by bus or other means. FIG. 9 shows the devices are connected by bus.

As a computer-readable storage medium, the memory 920 can store the non-volatile software program and non-volatile computer-executable program and module such as the program instructions/module corresponding to the method for synchronously playing multiple-cameras video of the embodiments of the present disclosure (for example, the information obtaining module 501, the request transmitting module 502 and the video playing module 503 in FIG. 8). By running the non-volatile software program, instructions and module, the processor 910 executes various functions and applications as well as the data processing of the server, that is, implements the method for synchronously playing multiple-cameras video provided in any method embodiments as shown in FIG. 1 to FIG. 4.

The memory 920 may include program storing area and data storing area, wherein the program storing area may store operating system, application for at least one function; the data storing area may store data created according to the using of the processing device for synchronously playing multiple-cameras video, and the like. Moreover, the memory 920 may include high-speed random access memory as well as non-volatile storage, such as at least one disk storage device, flash memory device, or other non-volatile solid-state memory device. In some embodiments, the memory 920 may further include the memory provided away from the processor 910. The remote memory can be connected to the processing device for synchronously playing multiple-cameras video via the network. The examples of the network include, but are not limited to the Internet, intranet, local area network, mobile communication network, and combinations thereof.

The input device 930 can receive input numbers or characters information, and create the key signal input related to the user settings and function controlling of the processing device for synchronously playing multiple-cameras video. The output device 940 may include the display device such as a display.

When the one or more modules stored in the memory 920 are processed by the one or more processors 910, the method for synchronously playing multiple-cameras video provided in any method embodiments as shown in FIG. 1 to FIG. 4 can be implemented.

The above-mentioned productions can execute the methods provided by the present disclosure, and have the function modules and advantageous effects corresponding to the methods. For the technical details that not described in detail in this embodiment, please find the methods provided by the embodiments of the present disclosure.

FIG. 10 is a block diagram of the embodiment 2 of the electronic device for synchronously playing multiple cameras video, provided by the present disclosure. As shown in FIG. 10, the device includes:

One or more processors 1010 and memory 1020. In FIG. 10, take one processor 1010 as the example.

The device configured to execute the method for synchronously playing multiple-cameras video may further include: input device 1030 and output device 1040.

The processor 1010, memory 1020, input device 1030 and output device 1040 can be connected by the bus or other means. In FIG. 10, as the example, they are connected by the bus.

As a computer-readable storage medium, the memory 1020 can store the non-volatile software program and non-volatile computer-executable program and module such as the program instructions/module corresponding to the method for synchronously playing multiple-cameras video of the embodiments of the present disclosure (for example, the information transmitting module 401, the request executing module 402 in FIG. 8). By running the non-volatile software program, instructions and module, the processor 1010 executes various functions and applications as well as the data processing of the server, that is, implements the method for synchronously playing multiple-cameras video provided in any method embodiments as shown in FIG. 5 to FIG. 7.

The memory 1020 may include program storing area and data storing area, wherein the program storing area may store operating system, application for at least one function; the data storing area may store data created according to the using of the processing device for synchronously playing multiple-cameras video, and the like. Moreover, the memory 1020 may include high-speed random access memory as well as non-volatile storage, such as at least one disk storage device, flash memory device, or other non-volatile solid-state memory device. In some embodiments, the memory 1020 may further include the memory provided away from the processor 1010. The remote memory can be connected to the processing device for synchronously playing multiple-cameras video via the network. The examples of the network include, but are not limited to the Internet, intranet, local area network, mobile communication network, and combinations thereof.

The input device 1030 can receive input numbers or characters information, and create the key signal input related to the user settings and function controlling of the processing device for synchronously playing multiple-cameras video. The output device 1040 may include the display device such as a display.

When the one or more modules stored in the memory 1020 are processed by the one or more processors 1010, the method for synchronously playing multiple-cameras video provided in any method embodiments as shown in FIG. 5 to FIG. 7 can be implemented.

The above-mentioned productions can execute the methods provided by the present disclosure, and have the function modules and advantageous effects corresponding to the methods. For the technical details that not described in detail in this embodiment, please find the methods provided by the embodiments of the present disclosure.

The electronic device in the embodiment of the present disclosure exists in various forms, including but not limited to:

(1) mobile communication apparatus, characterized in having a function of mobile communication mainly aimed at providing speech and data communication, wherein such terminal includes: smart phone (such as iPhone), multimedia phone, functional phone, low end phone and the like.;

(2) ultra mobile personal computer apparatus, which falls in a scope of personal computer, has functions of calculation and processing, and generally has characteristics of mobile internet access, wherein such terminal includes: PDA, MID and UMPC devices, such as iPad;

(3) portable entertainment apparatus, which can display and play multimedia contents, and includes audio or video player (such as iPod), portable game console, E-book and intelligent toys and portable vehicle navigation apparatus;

(4) server, an apparatus for providing computing service, constituted by processor, hard disc, internal memory, system bus, and the like, which has a framework similar to that of a computer, but is demanded for superior processing ability, stability, reliability, security, extendibility and manageability due to that high reliable services are desired; and

(5) other electronic devices having a function of data interaction.

The above mentioned examples for the apparatus are merely exemplary, wherein the unit illustrated as a separated component may be or may not be physically separated, the component illustrated as a unit may be or may not be a physical unit, in other words, may be either disposed in some place or distributed to a plurality of network units. All or part of modules may be selected as actually required to realize the objects of the present disclosure. Such selection may be understood and implemented by ordinary skill in the art without creative work.

According to the description in connection with the above embodiments, it can be clearly understood by ordinary skill in the art that various embodiments can be realized by means of software in combination with necessary universal hardware platform, and certainly, may further be realized by means of hardware. Based on such understanding, the above technical solutions in substance or the part thereof that makes a contribution to the prior art may be embodied in a form of a software product which can be stored in a computer-readable storage medium, such as ROM/RAM, magnetic disk and compact disc, and includes several instructions for allowing a computer device (which may be a personal computer, a server, a network device or the like) to execute the methods described in various embodiments or some parts thereof.

Finally, it should be stated that, the above embodiments are merely used for illustrating the technical solutions of the present disclosure, rather than limiting them. Although the present disclosure has been illustrated in details in reference to the above embodiments, it should be understood by ordinary skill in the art that some modifications can be made to the technical solutions of the above embodiments, or part of technical features can be substituted with equivalents thereof. Such modifications and substitutions do not cause the corresponding technical features to depart in substance from the spirit and scope of the technical solutions of various embodiments of the present disclosure.

What is claimed is:

1. A method for synchronously playing multiple-cameras video, comprising:
at an electronic device:
obtaining multiple-cameras video data source information of a video program from a network server, and generating and displaying a camera site information list;
setting up a main play window and at least one subordinate play window;
determining a camera site selected by a user after obtaining a first click operation of the user on the camera site information list, and transmitting a request for obtaining first selected camera video data to the network server;
playing video content of the first selected camera site on the main play window after the first selected camera video data is received;
determining a camera site selected by the user after obtaining a second click operation of the user on the camera site information list, and transmitting a request for obtaining second selected camera video data to the network server; and
playing video content of the second selected camera site on the at least one subordinate play window after the second selected camera video data is received.

2. The method for synchronously playing multiple-cameras video according to claim 1, wherein the transmitting of a request for obtaining the second selected camera video data to the network server comprises:
requesting the second selected camera video data to be compressed and obtaining the compressed second selected camera video data;
the receiving the second selected camera video data comprises: receiving the compressed second selected camera video data.

3. The method for synchronously playing multiple-cameras video according to claim 1,further comprising:
receiving an instruction for adding or deleting the subordinate play window, and adding or deleting the subordinate play window according to the instruction.

4. A non-volatile computer-readable storage medium, which stores computer-executable instructions, when executed by an electronic device, causes the electronic device to:
obtain multiple-cameras video data source information of a video program from a network server, and generate and display a camera site information list;
set up a main play window and at least one subordinate play window;
determine a camera site selected by a user after obtaining a first click operation of the user on the camera site information list, and transmit a request for obtaining first selected camera video data to the network server;
play video content of the first selected camera site on the main play window after the first selected camera video data is received;
determine a camera site selected by the user after obtaining a second click operation of the user on the camera site information list, and transmit a request for obtaining second selected camera video data to the network server; and
play video content of the second selected camera site on the at least one subordinate play window after the second selected camera video data is received.

5. The non-volatile computer-readable storage medium according to claim 4, wherein the transmitting of a request for obtaining the second selected camera video data to the network server comprises:
requesting the second selected camera video data to be compressed and obtaining the compressed second selected camera video data;
the receiving the second selected camera video data comprises: receiving the compressed second selected camera video data.

6. The non-volatile computer-readable storage medium according to claim 4, the electronic device is further caused to:
receive an instruction for adding or deleting the subordinate play window, and add or delete the subordinate play window according to the instruction.

7. An electronic device, comprising:
at least one processor; and
a memory communicably connected with the at least one processor for storing instructions executable by the at least one processor, and the instructions are executed by the at least one processor to cause the at least one processor to:
obtain multiple-cameras video data source information of a video program from a network server, and generate and display a camera site information list;
set up a main play window and at least one subordinate play window;
determine a camera site selected by a user after obtaining a first click operation of the user on the camera site information list, and transmit a request for obtaining first selected camera video data to the network server;
play video content of the first selected camera site on the main play window after the first selected camera video data is received;
determine a camera site selected by the user after obtaining a second click operation of the user on the camera site information list, and transmit a request for obtaining second selected camera video data to the network server; and
play video content of the second selected camera site on the at least one subordinate play window after the second selected camera video data is received

8. The electronic device according to claim 7, wherein the transmitting of a request for obtaining the second selected camera video data to the network server comprises:
requesting the second selected camera video data to be compressed and obtaining the compressed second selected camera video data;
the receiving the second selected camera video data comprises: receiving the compressed second selected camera video data.

9. The electronic device according to claim 7, the at least one processor is further caused to:
receive an instruction for adding or deleting the subordinate play window, and add or delete the subordinate play window according to the instruction.
